(19) United States
(12) Patent Application Publication
(10) Pub. No.: US 2009/0285125 A1
(43) Pub. Date: Nov. 19, 2009

(54) Iterative synchronous and Asynchronous Multi-User Detection with Optimum Soft limiter

(76) Inventors: Farokh Marvasti, Tehran (IR); Pedram Pad, Tehran (IR); Mahmood Ferdosy Naeiny, Tehran (IR)

Correspondence Address: BARRY CHOOBIN, TALEGHANI, BAHARE SHOMALI , #219, SUITE#18, TEHRAN, 1563714311, IR

(21) Appl. No.: 12/122,668

(22) Filed: May 17, 2008

(51) Int. Cl. H04L 12/28

(52) U.S. Cl. 370/255

(57) ABSTRACT

An iterative method for multi-user detection in Code Division Multiple Access (CDMA) Systems is used to improve the capacity of the network for random codes. A soft limiter function is used in the output of each step of iterations to accelerate the convergence and also to improve the interference cancellation power of this method.

### CROSS-REFERENCE TO RELATED APPLICATION

Not applicable

### BACKGROUND OF THE INVENTION

1. Field of the Invention

The invention relates to a CDMA system, including a transmitter and receiver, for use in e.g. a digital wireless communications system. In particular, the invention relates to a method of and apparatus for improving the capacity of the network for random codes.

2. Description of Related Art

Multi-user detection algorithms often use the information of all users in parallel to reduce the interference. One of the basic ideas is to estimate the interference of other users and to cancel its effect before the decision. This idea was used in the Parallel Interference Cancellation (PIC) method. In this method, the outputs of match filter banks are used to estimate the interference. This procedure can be repeated to have a better estimation of the interference. Some modified versions of PIC method have also been considered in the literature.

In CDMA systems, several users transmit their information bits using different signature codes. At the receiver side, the sum of transmitted signals of all users will be received and the signature codes are used to separate the transmitted information symbols. For a matched filter receiver, the received signal is correlated with the signature code of each user to extract its transmitted information symbol. But the performance of this receiver is highly affected by the interfering CDMA users. There is thus a requirement for a different multi-user interference cancellation method and system.

### SUMMARY OF THE INVENTION

The present invention discloses an iterative method for general distortion compensation to cancel the multi-user interference in CDMA systems. A decision function (called semi-soft) is introduced that can be used in the output of each iteration to improve the performance which increases the capacity of the network. The threshold parameter of this semi-soft decision function is optimized. The disclosed iterative method is expandable to the asynchronous CDMA case.

### BRIEF DESCRIPTION OF THE DRAWINGS

An embodiment of the invention is described below and with reference to the following figures in which:

FIG. 1 shows a conventional DS-CDMA transmitter block diagram.

FIG. 2 shows a conventional iterative algorithm for distortion compensation.

FIG. 3 shows a block diagram of distortion G according to the invention.

FIG. 4 shows soft limiter transfer function.

FIG. 5 shows simulation results.

FIG. 6 shows the overloaded result.

### DETAILED DESCRIPTION

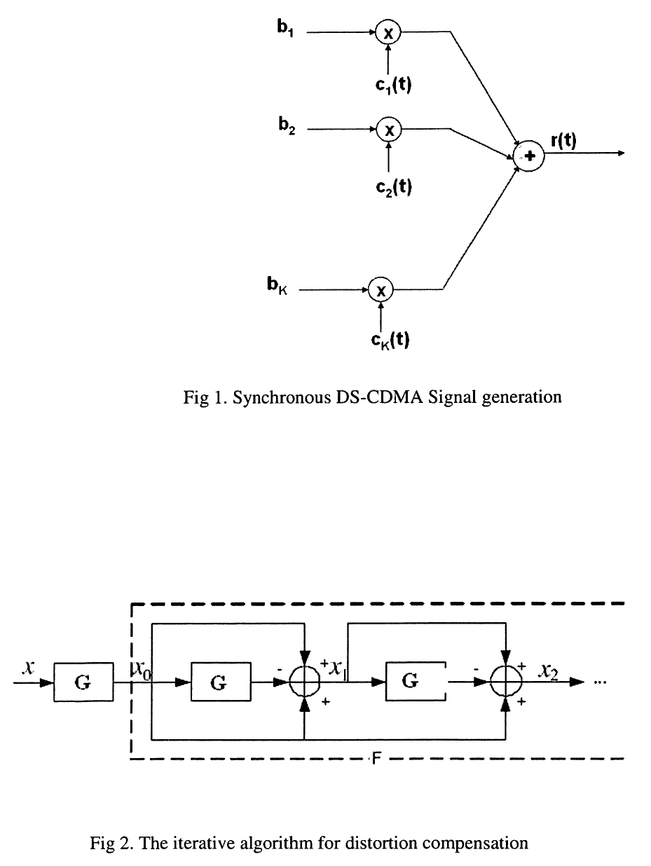

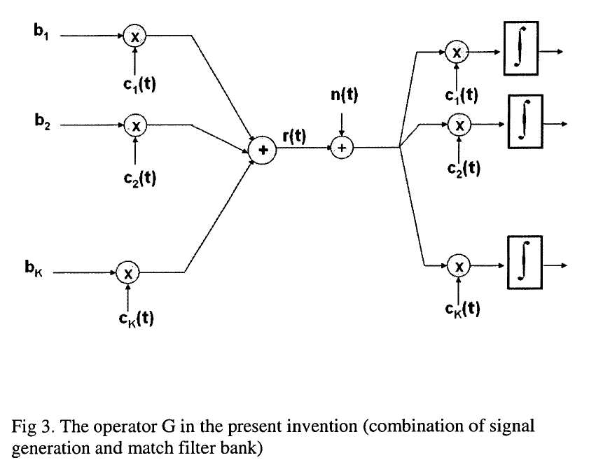

In CDMA systems with K users, the received signal in a bit interval can be modeled as:

$$r ( t ) = {\sum }_{i = 1}^{K} {b}_{i} {s}_{i} ( t ) + n ( t ) 0 \leq t < T \qquad ( 1 )$$

where bᵢ ε {±1} and sᵢ(t) are the BPSK modulated data and signature code of the ith user and n(t) is Additive White Gaussian Noise (AWGN) (FIG. 1). For a Matched Filter (MF) receiver (FIG. 3.), the received signal r(t) is correlated with the signature code of the j^{th} user to extract the transmitted bit bⱼ. The output of the MF decoder for the j^{th} user is:

$${y}_{j}^{( 0 )} = {\int }_{0}^{T} r ( t ) {s}_{j} ( t ) d t = {b}_{j} + {\sum }_{i = 1 , i \neq j}^{K} {R}_{ij} {b}_{i} + {n}_{j} \qquad ( 2 )$$

where Rᵢⱼ is the correlation of signature codes sᵢ(t) and sⱼ(t) and nⱼ is correlation of n(t) and sⱼ(t). The second term of equation (1) is the multi-user interference. Because the codes are not orthogonal, other users interfere at the output of the match filters.

Assumendo that a signal x is affected by a distortion operator G. Then the signal x is recovered from its distorted version (FIG. 2) as:

x₀=G(x), xₙ₊₁=λx₀+xₙ−λG(xₙ) (3)

where λ is the relaxation parameter that can control the stability and convergence rate of this method. Under some conditions it has been proven that

$$lim {{x}_{n}}_{n -> ∞} = x .$$

This technique is used to remove the CDMA multi-user interference. The operator G can be defined as G(b)=Rb, where b=(b₁,b₂, . . . ,b_{K})^{T} is the vector of transmitted symbols and R is the correlation matrix of signature codes. Where can be shown that:

$${y}_{j}^{( m + 1 )} = {y}_{j}^{( m )} + λ {y}_{j}^{( 0 )} - λ {\sum }_{i = 1}^{K} {R}_{ij} {y}_{j}^{( m )} \qquad ( 4 )$$

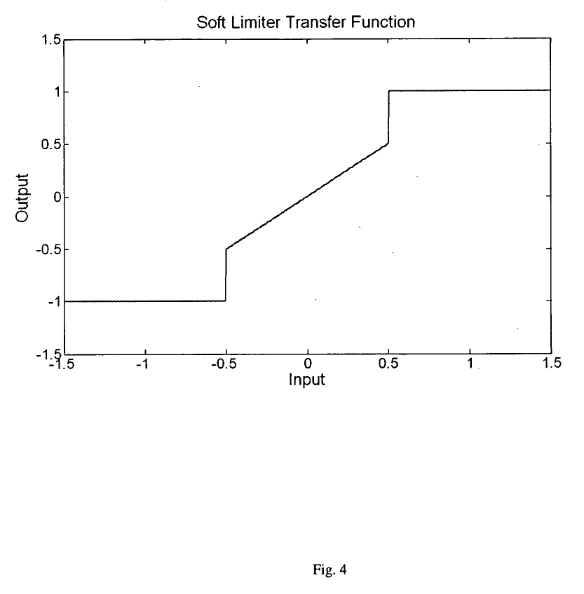

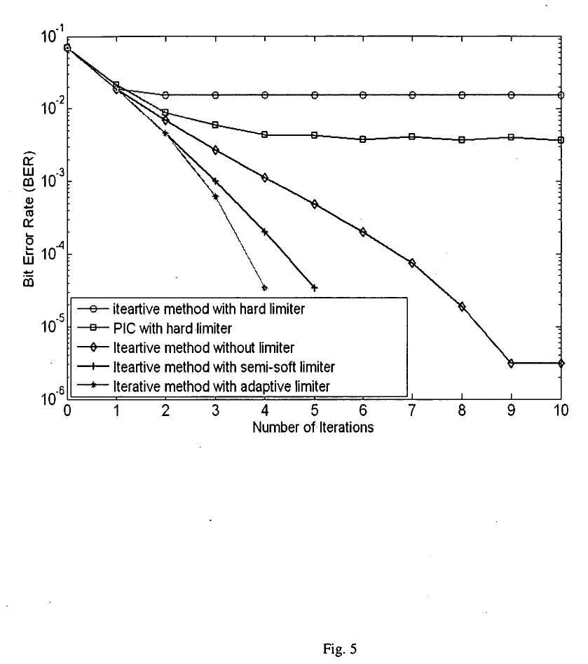

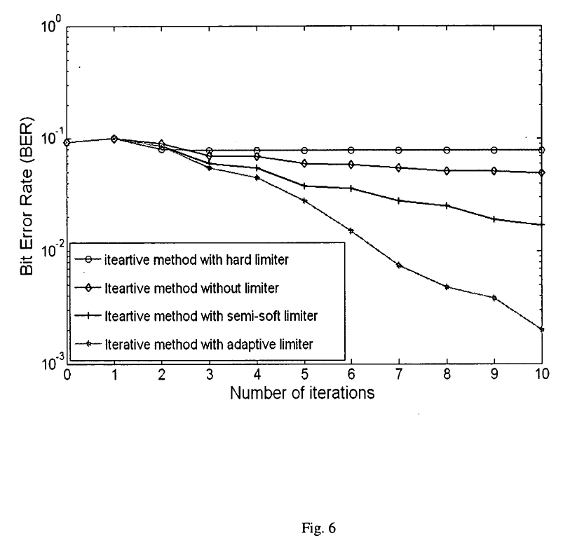

After each steps of iteration, the present invention uses a soft limiter as shown in FIG. 4. This soft-limiter clips the input symbols with amplitudes higher than a predetermined threshold (mapped to +1 and −1), otherwise they are kept unchanged. Since the interference is reduced with each iteration, the present invention discloses reducing the threshold adaptively after each iteration. The optimum threshold for a large range of SNRs is 0.6. FIG. 5 shows the simulation results (bit error rate versus the number of iterations) for 40 users using codes of length 64. In this figure, the proposed iterative method without soft-limiter and with optimum parameter λₒₚₜ=0.5 has a better performance than ordinary PIC. It also shows that the soft-limiter significantly improves the performance. FIG. 6 shows the overloaded result when the number of users, 70, is greater than the code length, 64. The adaptive soft-limiter threshold starts with an initial value of 0.6 for the threshold and is divided by 1.2 after each iteration step. Since we do not have any orthogonally assumption about the codes, this multi-user detection method can be used in the asynchronous case. In this case the operator G is also the combination of asynchronous CDMA generation and a bank of match filters that are synchronized with the users one by one. The results of asynchronous multi-user detection are similar to the synchronous case.

In another embodiment for a special class of signature codes for overloaded CDMA, the present invention discloses another decoding method for synchronous CDMA systems. Where said method is equivalent to a Maximum Likelihood (ML) decoder but with much lower computational cost than the straight implementation of ML decoders.

Let C_{m×n}=[A_{m×m}|B] be the code matrix where A is an invertible matrix. Assume that Y=CX+G is the received vector corresponding to transmission of CX through an AWGN channel (G represents the noise vector). Let

$${Z}_{1} = {\text{arg} min}_{{U}_{2}} ‖ {A}^{- 1} ( Y - {BU}_{1} ) - sgn ( {A}^{- 1} ( Y - {BU}_{1} ) ) ‖$$

and

Z₂=sgn(A⁻¹(Y−BZ₁)).

Now Z=[Z₂|Z₁]^{T} is the output of decoder corresponding to the input Y.

If C is an invertible matrix [8] and A is a Hadamard matrix, then the above decoder is equivalent to ML decoder. However, the computational cost of this method is much less than the standard ML algorithms.

### EXAMPLE

By using this method, having a 64×104 code matrix which is generated by methods introduced in “Errorless codes for over-loads synchronous CDMA system and evaluation of channel capacity bounds” which is incorporated here be reference, then C=H₈\textcircled{×}C_{8×13} where H₈ is a 8×8 Hadamard matrix and C_{8×13} is an invertible matrix. Suppose Y=CX+G is received, for ML decoding of Y, follow the following steps:
1—W=[W₁^{T} W₂^{T} W₃^{T} W₄^{T} W₅^{T} W₆^{T} W₇^{T} W₈^{T}]^{T}=(H₈⁻¹\textcircled{×}H₈⁻¹)Y. (Wᵢ's are 8-tuple vectors)
2—For each 1≦i≦8 find

$${Z}_{i 1} = {\text{arg} min}_{U} ‖ ( {W}_{i} - {H}_{8}^{- 1} BU ) - sgn ( {W}_{i} - {H}_{8}^{- 1} BU ) ‖ .$$

(Needs 32 Euclidean distance computation and selecting the least one)
3—For each 1≦i≦8 let

Zᵢ₂=sgn(Wᵢ−H₈⁻¹BZᵢ₁),
4—Z=[Z₁₂^{T} Z₁₁^{T} Z₂₂^{T} Z₂₁^{T} Z₃₂^{T} Z₃₁^{T} Z₄₂^{T} Z₄₁^{T} . . . Z₅₂^{T} Z₅₁^{T} S₆₂^{T} S₆₁^{T} Z₇₂^{T} Z₇₁^{T} Z₈₂^{T} Z₈₁^{T}
Z is a 104-tuple ±1 vector which is the output of decoder.

It is worth mentioning that for extracting the bit of one user, it is sufficient to perform steps 2 and 3 only for one of the Wᵢ's

The foregoing description of exemplary embodiments of the present invention provides illustration and description, but is not intended to be exhaustive or to limit the invention to the precise form disclosed. Modifications and variations are possible in light of the above teachings or may be acquired from practice of the invention.

I claim:

1. A method for improving capacity of network for random access codes comprising:
employing an iterative algorithm comprising at least one step of iteration;
using a soft limiter function in output of at least one step of iteration, wherein said function accelerates convergence rate and improves interference cancellation power.

2. A method as claimed in claim 1, wherein said method further comprises: tuning a relaxation parameter and wherein said iterative algorithm is used with at least two iterations.

3. A method as claimed in claim 1, wherein said method is used in asynchronous link.

4. A method as claimed in claim 1, wherein said method further comprises: using said method in an overloaded case where said overload case characterized in that the number of users and the number of code length, wherein the number of users is greater than the number code length.

5. A method as claimed in claim 1, wherein said method further comprises: decoding algorithm, wherein said decoding algorithm characterized in that maximum likelihood and code matrix wherein said code matrix is invertible.
